(19) United States
(12) Patent Application Publication
(10) Pub. No.: US 2007/0264411 A1
(43) Pub. Date: Nov. 15, 2007

(54) PROCESS OF PRODUCING A CAPSINOID-CONTAINING FOOD AND DRINK

(75) Inventors: Yoko Ito, Kanagawa (JP); Fumiko Watanabe, Kanagawa (JP); Kentaro Maruyama, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: AJINOMOTO CO., INC., Tokyo (JP)

(21) Appl. No.: 11/695,198

(22) Filed: Apr. 2, 2007

Related U.S. Application Data
(60) Provisional application No. 60/805,493, filed on Jun. 22, 2006.

(30) Foreign Application Priority Data
Mar. 31, 2006 (JP) 2006-098623

(51) Int. Cl. A23D 7/00

(52) U.S. Cl. 426/602

(57) ABSTRACT

The present invention provides a process of producing a capsinoid-containing food and drink with a superior stability of the capsinoid compound, and an emulsion composition comprising a capsinoid compound with an improved dilution stability thereof. The process entails blending an oil phase containing a capsinoid compound with an aqueous phase and an emulsifier to prepare an emulsion composition, and mixing the emulsion composition with an aqueous component, wherein an additional emulsifier and/or a high-molecular component is added to the emulsion composition, the aqueous component or a mixture thereof.

### CROSS-REFERENCE TO RELATED APPLICATIONS

The present application claims priority to Japanese Application No. JP 2006-098623, filed on Mar. 31, 2006, and U.S. 60/805,493, filed on Jun. 22, 2006, which are hereby incorporated by reference in their entirety.

### BACKGROUND OF THE INVENTION

1. Field of the Invention

The present invention provides a process for producing a capsinoid-containing food and/or drink. More particularly, the present invention provides a process for producing a water-containing food and/or drink by preparing an emulsion composition and diluting the emulsion composition.

2. Discussion of the Background

It has been reported that a non-pungent cultivar of Capsicum, named “CH-19 sweet” which was selected and fixed by Yazawa et al. as a low hot pepper contains considerable amounts of new non-pungent capsinoids (see, for example, Yazawa et al., Engei Gakkai Zasshi (Journal of the Japanese Society for Horticultural Science) vol. 58, 601-607 (1989)). The compounds belonging to capsinoids (fatty acid esters of vanillyl alcohol, capsiate, dihydrocapsiate, etc., hereinafter sometimes merely referred to as “capsinoid compound”, “capsinoid” or “capsinoids”) are non-pungent, different from pungent components of red pepper, capsaicinoids (capsaicin, dihydrocapsaicin, etc.), but they have been reported to exhibit an immune activating action, activation effect for energy metabolism, and the like (see JP Patent Kokai Publication No. JP-A-11-246478), and are expected to be put into medicinal practice in the future.

Capsinoids are very unstable because the ester linkage formed between a vanilloid group and a fatty acid chain is readily hydrolyzed. Therefore, a technique for solubilizing capsinoids in water has been required to add capsinoids into a liquid food product such as beverage with keeping stability. To this end, a technique for emulsifying an oil containing capsinoid with an emulsifier to yield an emulsion and solubilizing the latter in water, has been reported (see, for example, JP Patent Kokai Publication No. JP-P2003-192576A). However, there remains a critical need for safe, convenient, and reproducible methods of solubilizing capsinoids in water. It is this need that the present invention addresses.

### SUMMARY OF THE INVENTION

When an emulsion composition prepared according in a conventional manner is merely diluted with an aqueous component to prepare a water-containing food and drink product (e.g., an aqueous beverage) the capsinoid compounds contained in the aqueous beverage slowly decompose during storage as compared to the product immediately after production. Thus, when preparing a healthy functional food product, it is necessary to assure the necessary amount capsinoid compounds that exhibit physiological function are maintained in the food product through the entire lifespan of the product from production up to the end of the shelf life. To this end, the amount of the components, including the capsinoid compounds, to be added during production is increased by estimating the amount that is expected to decompose during the shelf life. However, due to manufacturing cost, it is desirable to reduce the extra amount of components to be added when preparing a healthy food product.

Accordingly, it is desired that a method be provided that results in an increased stability of capsinoid compounds in an aqueous solution. In preparing a capsinoid-containing emulsion composition, increase of the concentration of an emulsifier may slightly improve the stability during dilution, but there is a possibility that the presence of a large quantity of emulsifier during emulsification may have a negative influence on the emulsifying action. Thus, there is an existing desire and need for a method for stably producing a capsinoid-containing aqueous food and drink product and a capsinoid-containing aqueous emulsion composition used therein of which the stability during dilution is improved.

The present inventors worked assiduously to solve the foregoing problems. As a result the present inventors found that addition of an additional emulsifier and/or a high molecular weight component during dilution of a capsinoid-containing emulsion composition with an aqueous component raises the stability of capsinoid when an oil phase containing the capsinoid compound is incorporated into an aqueous phase in an emulsified state.

Therefore, the process of producing a capsinoid-containing food and/or drink in the present invention entails blending an oil phase containing a capsinoid compound with an aqueous phase and an emulsifier to prepare an emulsion composition; and mixing the emulsion composition with an aqueous component, wherein an additional emulsifier and/or a high-molecular component is added to the aforementioned emulsion composition, aqueous component or a mixture thereof. The additional emulsifier and/or high-molecular component may be added in the step in which the aforementioned emulsion composition is mixed with the aqueous component, or may be added to either or both of the aforementioned emulsion composition and the aforementioned aqueous component before mixing the aforementioned emulsion composition with the aqueous component. In addition, the stability of the capsinoid-containing emulsion composition can be increased by further adding an oil thickener to the aforementioned oil phase.

In another aspect of the invention, the present invention provides an emulsion composition with an improved dilution stability of a capsinoid compound contained therein. This emulsion composition is preferably prepared by blending an oil phase containing a capsinoid compound, an aqueous phase and an emulsifier, and supplemented with an additional emulsifier and/or a high molecular weight component.

According to the present invention, the capsinoid compound contained in the food and/or drink product prepared by diluting a capsinoid-containing emulsion composition using the aqueous component is improved in its stability. Thus, the improvement extends the shelf life of the product and contributes to a manufacturing cost reduction.

The above objects highlight certain aspects of the invention. Additional objects, aspects and embodiments of the invention are found in the following detailed description of the invention.

### BRIEF DESCRIPTION OF THE FIGURES

A more complete appreciation of the invention and many of the attendant advantages thereof will be readily obtained as the same becomes better understood by reference to the following Figures in conjunction with the detailed description below.

FIG. 1 shows the storage stability of dihydrocapsiate in a medium containing decaglycerin monooleate (trade name: DECAGLYNL 1-O).

FIG. 2 shows the storage stability of dihydrocapsiate in media containing 8 types of emulsifiers.

FIG. 3 shows the storage stability of dihydrocapsiate in media containing 8 types of high molecular weight components.

FIG. 4 shows the storage stability of dihydrocapsiate when a capsinoid-containing emulsion preparation was diluted in a different way. (A) indicates a case wherein a capsinoid-containing emulsion preparation was diluted with an aqueous buffer containing an emulsifier; (B) indicates a case wherein a capsinoid-containing emulsion preparation, to which was added an emulsifier in advance, was diluted with an aqueous buffer containing no emulsifier.

### DETAILED DESCRIPTION OF THE INVENTION

Unless specifically defined, all technical and scientific terms used herein have the same meaning as commonly understood by a skilled artisan in the food sciences.

All methods and materials similar or equivalent to those described herein can be used in the practice or testing of the present invention, with suitable methods and materials being described herein. All publications, patent applications, patents, and other references mentioned herein are incorporated by reference in their entirety. In case of conflict, the present specification, including definitions, will control. Further, the materials, methods, and examples are illustrative only and are not intended to be limiting, unless otherwise specified.

The present invention will be further explained in detail by the following, which is not intended to limit the scope of the invention.

Capsinoid Compounds:

In the present invention, “capsinoid compounds” refer to fatty acid esters of vanillyl alcohol. As representative components are those confirmed as components contained in capsicum, including capsiate, dihydrocapsiate, and nordihydrocapsiate; further including fatty acid esters comprising vanillyl alcohol and a variety of straight or branched chain fatty acids which have approximately the same fatty acid length as capsiate or nordihydrocapsiate such as vanillyl decanoate, vanillyl nonanoate, vanillyl octanoate, and the like. Capsiate (hereinafter sometimes abbreviated to “CST”), dihydrocapsiate (hereinafter sometimes abbreviated to “DCT”) and nordihydrocapsiate (hereinafter sometimes abbreviated to “NDCT”) can be represented by the following chemical formulae.

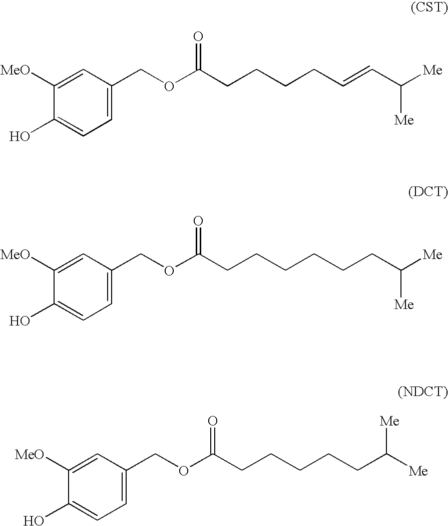

Capsinoids are abundant in the plant body of a plant belonging to a genus Capsicum (hereinafter referred to “red pepper”). These compounds can be prepared by separation and purification from the plant body and/or fruit of red pepper. There is no limitation in species of red pepper used in purification as far as it contains capsinoids. However, it is preferable to use a non-pungent variety of red pepper, though one derived from a native variety of pungent red pepper exemplified by “Nikko” and “Goshiki” may be used. In particular, non-pungent variety such as “CH-19 sweet”, “Man-ganji”, “Fushimi Kancho”, and the like, or green pepper, sweet green pepper, and the like can preferably be employed since they contain a large amount of capsinoid compounds. A non-pungent variety “CH-19 sweet” is particularly preferred because the content of said components is particularly high. The term “CH-19 sweet” refers to a variety “CH-19 sweet” and its descendant relatives derived from “CH-19 sweet”.

Purification and separation of the capsinoid compounds can be performed in a conventional manner that is well known by a person skilled in the art. The following example of such a method can be used: extraction with a solvent, a variety of chromatography such as silica gel chromatography, preparative high performance liquid chromatography, etc. alone or in combination of these ways. A further example that may be used includes the method as described in JP Patent Kokai Publication No. JP-A-11-246478.

Alternatively, the capsinoid compounds may be synthesized by an ester exchange reaction of the corresponding fatty acid ester and vanillyl alcohol as starting materials, for example, as described in P Patent Kokai Publication No. JP-A-11-246478. It is also possible to synthesize capsinoid compounds based on its chemical structure according to other reaction techniques well known by a person skilled in the art. Moreover, capsinoids can readily be prepared by a synthetic process using an enzyme catalyst. For example, a desired capsinoid compound can be readily obtained by a reverse reaction of lipase using a fatty acid ester corresponding to the desired compound, and/or a compound such as triglyceride containing said fatty acid, and vanillyl alcohol as substrates. Such an enzymatic method is described in JP-A-2000-312598 or Kobata et al., Biosci. Biotechnol. Biochem., 66(2), 319-327 (2002).

The capsinoid compounds used in the present invention may be any of the above-mentioned extraction products or synthetic products. Further, these compounds may be a single compounds or a mixture of two or more compounds. Further, the capsinoid compounds to be used may contain their decomposition products, i.e., free fatty acids or vanillyl alcohol.

Oil Phase:

The oil phase containing a capsinoid compound refers to a fat-soluble material prepared by blending the above-mentioned capsinoid compound with fats and oils. The fats and oils include, for example, vegetable oils such as soybean oil, coconut oil, rice oil, corn oil, palm oil, safflower oil, rapeseed oil, olive oil, and the like; middle chain saturated fatty acid triglycerides (hereinafter also referred to as “MCT”) constituted by glycerin and fatty acids including saturated fatty acids of 6 to 10 carbon atoms (for example, capric acid, caprylic acid, etc.) as major constituents; animal fats and oils such as beef tallow, lard, chicken fat, and fish oil; fatty acids such as oleic acid; and their mixtures. In addition, sucrose acetate isobutyrate (SAIB), various Rosin esters, and Elemi resins may be added as a specific gravity adjuster.

Oil Thickener:

The oil phase containing a capsinoid compound preferably contains the following oil thickener in addition to the above-mentioned fats and oils. There is no limitation in an oil thickener used in the invention as far as it shows a thickening effect when dissolved in an oil preparation, including for example fat-solidifying agent such as long chain fatty acid esters. As the long chain fatty acid esters, those of 20 or more carbon atoms are preferred. The fatty acid esters of 20 or more carbon atoms, for example, includes esters of arachic acid, behenic acid, etc. with propylene glycol, glycerin, sorbitan, pentaerythritol, diglycerin, etc. Specifically, the esters include, but are not limited to, glycerin monobeheniate, glycerin monoarachiate, sorbitan diarachiate, and the like. In particular, hexaglycerin octastearate, monoglycerin monobeheniate, and their mixture are preferred, and specifically a commercially available “TAISET” (trade name by Taiyo Chemical Co.) is exemplified.

The amount of the oil thickener to be added is determined as an amount of the thickener by which addition the viscosity of hydrophobic component before addition of the thickener is improved. For example, the amount of oil thickener to be added may be 0.1-10% by mass, preferably 0.5-5% by mass, more preferably 1-3% by mass based on the total mass of the oil phase. Thus, the viscosity of the capsinoid-containing oil phase is adjusted preferably to a viscosity of 50-350 mPa·s by addition of the oil thickener. The viscosity can be determined by a conventional method well known by a person skilled in the art, for example, using a conventional measuring apparatus such as rotating viscosimeter, capillary viscosimeter, falling sphere viscosimeter, and the like.

Aqueous Phase:

The aqueous phase in the present invention is used in preparation of an oil-in-water type emulsion composition due to emulsifying the above-mentioned oil phase. If required, saccharides such as sugar, glutinous starch syrup, etc., polyhydric alcohols such as glycerin, sorbitol, propylene glycol, etc., organic acids such as citric acid, malic acid, etc., salts such as sodium chloride, potassium chloride, calcium chloride, etc., anti-oxidant, β-carotene, pigments such as paprika pigment, etc. may be properly blended.

The aqueous phase may preferably be adjusted to an acidic range, more preferably pH 2-6. The acidic material used in adjusting the pH includes, but not particularly limited to, for example, organic acids or their salts such as citric acid, adipic acid, succinic acid, tartaric acid, lactic acid, fumaric acid, DL-malic acid, benzoic acid, gluconic acid, gluconodeltalactone, and the like; salts such as potassium carbonate, sodium bicarbonate, sodium carbonate, sodium dihydrogen pyrophosphate, and the like; inorganic acids and their salts such as phosphoric acid; vitamin C and its salts. These acidic materials are used in adjustment of the pH of an emulsion composition to an acidic range, allowing maintenance of the stability of capsinoid compounds for long term storage.

Emulsifier:

There is no particular limitation placed on the emulsifiers for use in the preparation of a capsinoid-containing emulsion composition. To this end, a variety of emulsifiers used heretofore in foods and/or drinks can be used. For example, monoglycerin fatty acid esters, diglycerin fatty acid esters, triglycerin fatty acid esters, monoglycerin fatty acid ester derivatives, propylene glycol fatty acid esters, sucrose fatty acid esters, polyglycerin fatty acid esters, polyoxyethylene sorbitan fatty acid esters, lecithin, modified starch, sorbitan fatty acid esters, gum arabic, gum ghatti, pectin, carrageenan, octinylsuccinic acid starch and quillai extract are included.

In particular, polyglycerin fatty acid esters are preferred in view of stability of emulsification. The amount of these emulsifiers is not strictly limited but they may be used in the wide range of amounts depending on their type. Usually, the emulsifier may be used in an amount ranging from 2-30% by mass, preferably about 3-25% by mass, for the total of an oil phase, aqueous phase and emulsifier. For example, when a polyglycerin fatty acid ester is used as an emulsifier, it is preferably used within the range of about 6-10% by mass. In such a case, the ratio of an emulsifier, an oil phase and an aqueous phase to be blended may be determined so that an emulsion composition of oil-in-water type is formed. With respect to the ratio, the skilled artisan can readily determine the same depending upon the type of oil and emulsifier chosen.

In producing a capsinoid-containing emulsion composition, an oil phase containing a capsinoid compound, preferably an oil phase containing the above-mentioned oil thickener, is blended with an aqueous phase and an emulsifier. This mixture is then emulsified by a conventional emulsifying method for fats and oils to prepare an emulsion composition. In a preferred embodiment, for example, an oil phase containing a capsinoid compound is first blended with an aqueous phase containing an emulsifier (the above-mentioned emulsifier is dissolved in water with heating), and if required adjusting the resulting emulsion composition at pH 2-6 with the above-mentioned acidic material, followed by mixing with a homomixer, colloid mill, high pressure homogenizer, and the like, to prepare an emulsion composition in which the capsinoid compound is highly stable.

After preparation of the above-mentioned emulsion composition, an additional emulsifier and/or a high molecular weight component may further be added. Increase of the concentration of an emulsifier and/or a high molecular weight component in an emulsion composition is effective in improvement of the stability of the capsinoid compound after dilution as described below.

A Process of Producing a Capsinoid-Containing a Food and/or Drink Product of the Invention:

The capsinoid-containing food and/or drink product of the present invention (herein referred to as “food and drink product of the invention” or “food and/or drink product of the invention”) is prepared by mixing the above-mentioned emulsion composition with an aqueous component. This mixing can be performed by diluting the emulsion component with an aqueous component. The invention is characterized in that an additional emulsifier and/or a high molecular weight component is further added to the above-mentioned emulsion composition, aqueous component or their mixture at any step of producing the above-mentioned food and drink product. In this regard, the aqueous component is a component constituting food and/or drink other than the emulsion component to be added, including for example an aqueous solution, oil-in-water type emulsion, gelled solution, and the like. Further, the aqueous solution is basically the same as the aqueous phase used in preparation of an emulsion composition.

When preparing an aqueous drink product, an aqueous solution containing fruit juice, vitamins, amino acids, perfume, sugars, and the like is preferably added to a capsinoid-containing emulsion composition to form a refreshing drink or a carbonated drink. When using an oil-in-water type emulsion as an aqueous component, frozen dessert such as ice-cream, a variety of dairy products such as yoghurt or milk, a variety of emulsified food and drink products such as cream caramel, mousse, bavarois, dressing, and the like can be produced. When using a gelled solution, a gelled food product such as jelly can be produced. These food and/or drink products preferably contain at least 10% by mass of moisture. The capsinoid-containing emulsion composition blended into these food and drink products may be used in the range of the amount by which oil drops contained in the above-mentioned emulsion composition are maintained, generally in the range of about 0.01- about 5% by mass for the food and drink product, though it changes depending on the purpose of use, sort of food and drink, and form.

In a preferred embodiment of the invention, an additional emulsifier and/or a high molecular weight component is added when emulsion composition is mixed with an aqueous component. Alternatively, it may be added to a capsinoid-containing emulsion composition and/or an aqueous component in advance. The above-mentioned emulsifier may be the same as that used in preparation of the emulsion composition, and in particular, polyglycerin fatty acid ester, sorbitan fatty acid ester, sucrose fatty acid ester, organic acid glycerin fatty acid ester, and polyoxyethylene sorbitan fatty acid ester are preferably used. These emulsifiers may be used alone or in combination of two or more species. The amount to be added may properly be optimized depending on the type or utility of the food and drink product to be produced, with no particular limitation, and it is, for example, 0.01-5% by mass, preferably 0.05-1% by mass for the total of the food and drink product.

On the other hand, the high molecular weight component includes naturally occurring or synthetic polysaccharides or proteins. The polysaccharides include gum arabic, gum ghatti, tragacanth gum, cyamoposis gum, karaya gum, xanthan gum, pectin, alginic acid and its salts, carrageenan, cellulose and its derivatives. The proteins include soybean protein, gelatin, collagen, casein, casein sodium, and the like, and these may be used alone or in combination of two or more. In particular, carrageenan, high methoxyl pectin (HM pectin), and carboxymethylcellulose sodium (CMC sodium) are preferred. Carrageenan is a naturally occurring high molecular weight substance of molecular weight being 100,000-500,000, extracted and purified from a sea weed, red algae, mainly composed of galactose and 3,6-anhydrogalactose. With respect to the molecular weight of carrageenan, the molecular weight may be either number-average molecular weight or weight-average molecular weight. Pectin is a naturally occurring high molecular weight polysaccharide mainly composed of galacturonic acid and methylgalacturonic acid; pectin in which methylgalacturonic acid occupies 50% or more to the total galacturonic acid is called HM pectin, while one containing lower than 50% called LM pectin. HM pectin has 55% or more of sugar content and is readily gelled around pH 3. CMC sodium is also called sodium cellulose glycolate and has been used as a thickener in food additives. The amount to be added may properly be optimized depending of the sort or utility of aqueous drink products with no particular limitation, and for example, it may be in 0.01-5% by mass, preferably 0.1-1% by mass for the total drink product.

The products produced by the process of the invention may be accompanied by a labeling indicating that these aqueous food and/or drink products activate an immune system, activate energy metabolism, and can be used in improvement of lifestyle related diseases. The labeling may be indicated on a package of the product or incorporated into a package as a package insert. In the indication, it is preferable to involve a specification describing a proper amount to be taken a day and a way of administration.

The present invention provides a process of producing a capsinoid-containing food and/or drink with a superior stability of the capsinoid compound, and an emulsion composition comprising a capsinoid compound with an improved dilution stability thereof. The process comprises blending an oil phase containing a capsinoid compound with an aqueous phase and an emulsifier to prepare an emulsion composition, and mixing the emulsion composition with an aqueous component, wherein an additional emulsifier and/or a high-molecular component is added to the emulsion composition, the aqueous component or a mixture thereof.

The process of the invention is utilizable in the fields of food products and cosmetics.

The above written description of the invention provides a manner and process of making and using it such that any person skilled in this art is enabled to make and use the same, this enablement being provided in particular for the subject matter of the appended claims, which make up a part of the original description. Preferred embodiments of the invention are similarly fully described and enabled.

As used above, the phrases “selected from the group consisting of,” “chosen from,” and the like include mixtures of the specified materials.

Where a numerical limit or range is stated herein, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

Having generally described this invention, a further understanding can be obtained by reference to certain specific examples, which are provided herein for purposes of illustration only, and are not intended to be limiting unless otherwise specified.

### EXAMPLES

As used in the Examples below, the symbol % means % by mass.

### Example 1

### Preparation and Evaluation of Stability of a Capsinoid Emulsified Preparation Diluent to Which an Emulsifier is Added

A dihydrocapsiate emulsion composition was prepared according to the method described in Example 1 of JP Patent Kokai Publication No. JP-P2003-192576A. Briefly, decaglycerin monooleate (Nikko Chemical Co.; trade name, DECAGLYN 1-O) (21 g), glycerin (193 g) and water (26 g) were mixed, dissolved under heating at 90-95° C., and cooled to 30° C. Synthetic dihydrocapsiate (8.5 g) and sucrose acetate isobutyrate (SAIB) (51 g) were added and dissolved under heating at 85-90° C., and the mixture was emulsified at 30-90° C. to prepare a capsinoid-containing emulsion composition (pH 3.6). The resulting emulsion composition was diluted with up to 1000 parts of 0.01M citrate buffer (pH 3.5) supplemented with sucrose to obtain an additive-free sample. On the other hand, the composition was diluted with up to 1000 parts of 0.01M citrate buffer (pH 3.5) supplemented with sucrose to which was added 0.014%, 0.114% emulsifier (Nikko Chemical Co.; DECAGLYN 1-0) respectively, to prepare emulsion-supplemented samples. The resulting samples were sterilized by heating for 20 minutes at 44° C. and stored.

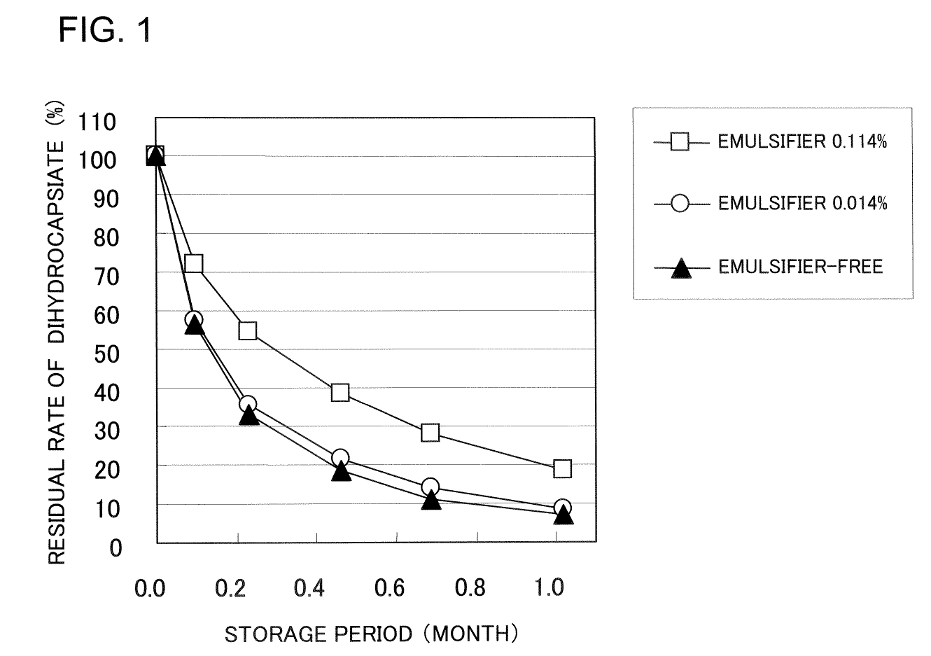

Every one week after storage, the capsinoid content was determined. Analysis of the capsinoid content was performed by high performance liquid chromatography (HPLC) after dilution with an ethyl acetate/methanol (6:4) mixture. FIG. 1 shows the result. As shown in FIG. 1, the result indicates that the storage stability of dihydrocapsinoate is increased with increase of the amount of emulsifier added. In a sample to which 0.114% emulsifier was added, the rate of residual dihydrocapsiate was 2 times and above more stable than the emulsifier-free case about one month after storage.

### Example 2

### Preparation and Evaluation of Stability of a Diluted Capsinoid Emulsified Solution to Which a Variety of Emulsifiers are Added

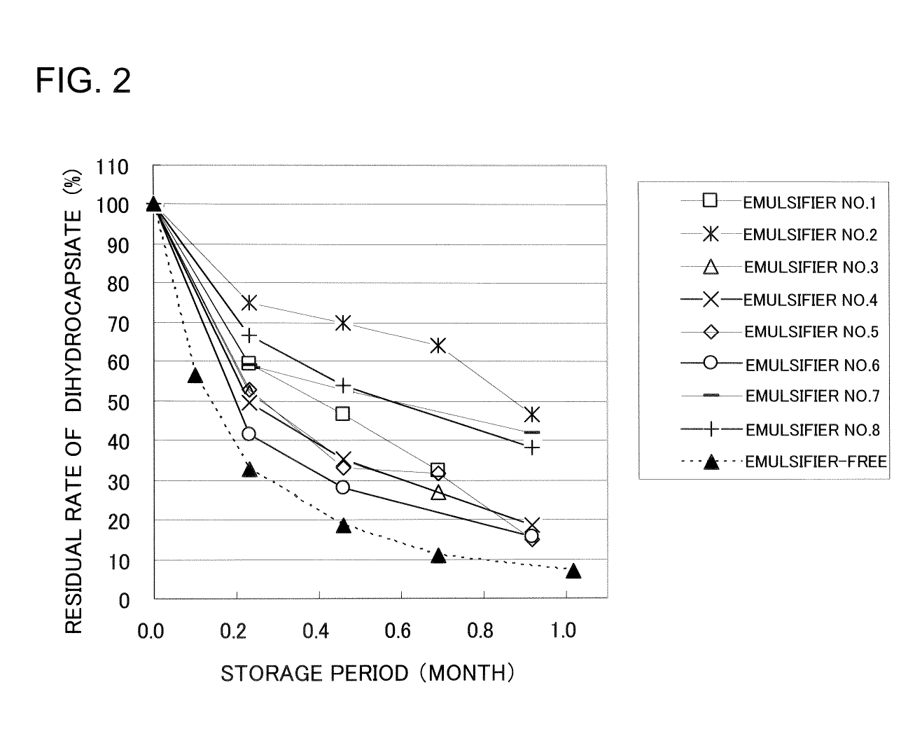

In the same manner as in Example 1, a dihydrocapsiate containing emulsion composition was diluted with up to 1000 parts of 0.01M citrate buffer (pH 3.5) supplemented with sucrose and the stability of storage was evaluated. Prior to addition of the dihydrocapsiate containing emulsion composition 8 types of emulsifiers were added to 0.01M citrate buffer (pH 3.5) supplemented with sucrose so as to be 0.114%, and the difference of the stability as a function of the emulsifier added was evaluated. Table 1 indicates the 8 species of emulsifiers added, and the results of storage are shown in FIG. 2. From the results of FIG. 2, it was recognized that the other emulsifiers than DECAGLYN 1-O improve the stability of dihydrocapsiate during storage.

TABLE 1

| Emuls. | | | |
|---|---|---|---|
| No. | Types of Emulsifiers | Trade Name | Manufacturer |
| 1 | Polyoxyethylene (20) | TWEEN 80 | Sigma-Aldrich |
| | sorbitan monooleate | | |
| 2 | Polyoxyethylene (5) | TWEEN 81 | Sigma-Aldrich |
| | sorbitan monooleate | | |
| 3 | Polyoxyethylene (20) | TWEEN 20 | Sigma-Aldrich |
| | sorbitan monolaurate | | |
| 4 | Decaglycerin | — | Taiyo Chem. Co. |
| | monomyristate | | |
| 5 | Decaglycerin | — | Taiyo Chem. Co. |
| | pentaoleate | | |
| 6 | Citric acid | SUNSOFT621B | Taiyo Chem. Co. |
| | monoglycerin stearate | | |
| 7 | Sucrose stearate | S1670 | Mitsubishi |
| | | | Chem. Co. |
| 8 | Sorbitan monooleate | SPAN 80 | Sigma-Aldrich |

### Example 3

### Preparation and Evaluation of Stability of a Diluted Capsinoid Emulsified Solution to Which a Variety of High Molecular Weight Components are Added

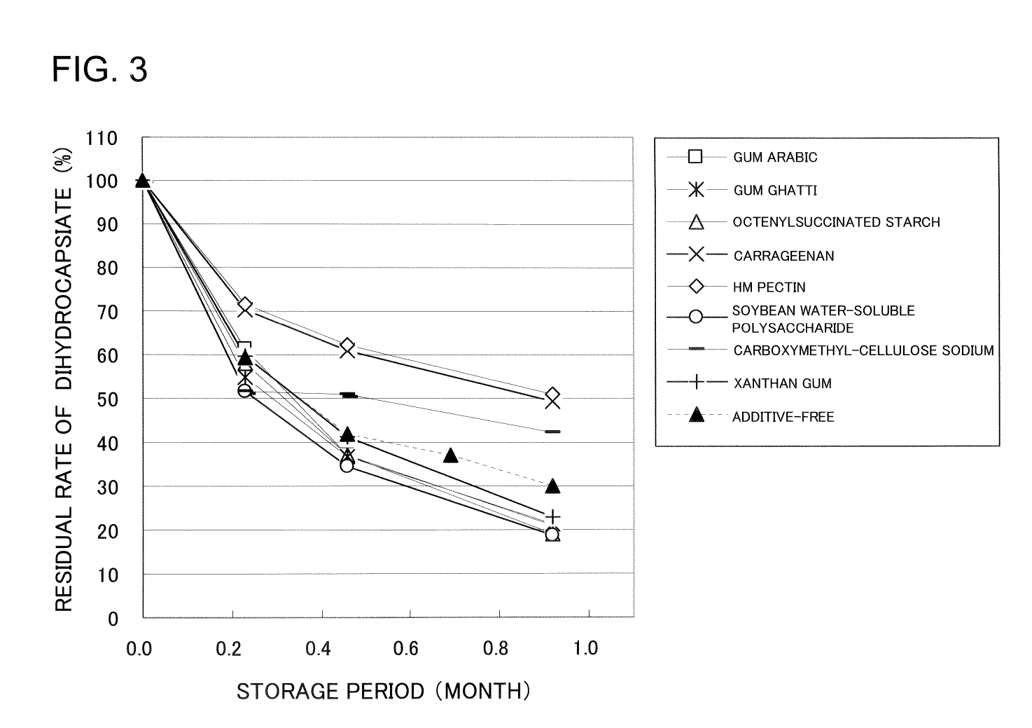

In the same manner as in Example 2, a dihydrocapsiate containing emulsion composition was diluted with up to 500 parts of 0.01M citrate buffer (pH 3.5) supplemented with sucrose and the stability of storage was evaluated. Prior to addition of the dihydrocapsiate containing emulsion composition 8 types of high molecular weight components were added to 0.01M citrate buffer (pH 3.5) supplemented with sucrose, and the difference of the stability as a function of the high molecular weight components added was evaluated. Table 2 shows the high molecular weight components evaluated. In regard to the amount of high molecular weight component to be added, xanthan gum was reduced to 0.1% because it gives high viscosity in a small quantity. The amount of other high molecular weight components added than xanthan gum was fixed at 0.5%. The results of storage are shown in FIG. 3. Improvement of the storage stability of dihydrocapsiate was recognized in HM pectin (⋄), carrageenan (×), and carboxymethylcellulose sodium (CMC sodium)(−).

TABLE 2

| Hi Mol. | | | |
|---|---|---|---|
| Comp. | | | |
| No. | Sort | Trade Name | Manufacturer |
| 1 | Gum arabic | SUPER GUM EM2 | Saneigen FFI |
| 2 | Gum ghatti | GUM GHATTI SD | Saneigen FFI |
| 3 | Octenylsuccinated | EMULSTAR#30 | Matsutani Chem. |
| | starch | | Ind. |
| 4 | Carrageenan | CARRAGEENIN CSL-1 | Saneigen FFI |
| 5 | HM pectin | YM-150-LJ | CP KELCO |
| 6 | Soybean water- | SOYBEAN FOOD | Saneigen FFI |
| | soluble | FIBER SM-1200 | |
| | polysaccharide | | |
| 7 | Carboxymethyl- | FTS-1 | Nippon Syn. |
| | cellulose | | Chem. Ind. |
| | sodium | | |
| 8 | Xanthan gum | SUN ACE NXG-S | Saneigen FFI |

### Example 4

### Preparation of a Composition in Which a Capsinoid Emulsion Composition was Mixed with an Emulsifier in Advance, and Evaluation of the Stability in a Diluent

Into a capsinoid emulsion composition prepared in Example 1 an emulsifier (Nikko Chemical Co., Decaglyn 1-O) was blended at a ratio of 10 to 3 under heating (50-70° C.) to prepare a composition. The resulting composition was diluted with up to 230 parts of 0.01M citrate buffer (pH 3.5) supplemented with sucrose to prepare a mixture of the emulsion composition and the emulsifier. On the other hand, an additive-free sample prepared by diluting the capsinoid emulsion composition (prepared in Example 1) with up to 300 parts of the same buffer was diluted with up to 300 parts of 0.01M citrate buffer (pH 3.5) supplemented with sucrose to which was added an emulsifier (Nikko Chemical Co., DECAGLYN 1-0) in advance at a rate of 0.10%, to prepare a sample containing an emulsifier. In either sample, the content of capsinoid after dilution with the buffer correspond to 0.33% of the initial amount of capsinoid existing in the emulsion composition. Thus prepared samples were sterilized under heat for 20 minutes and stored at 24° C. and 44° C.

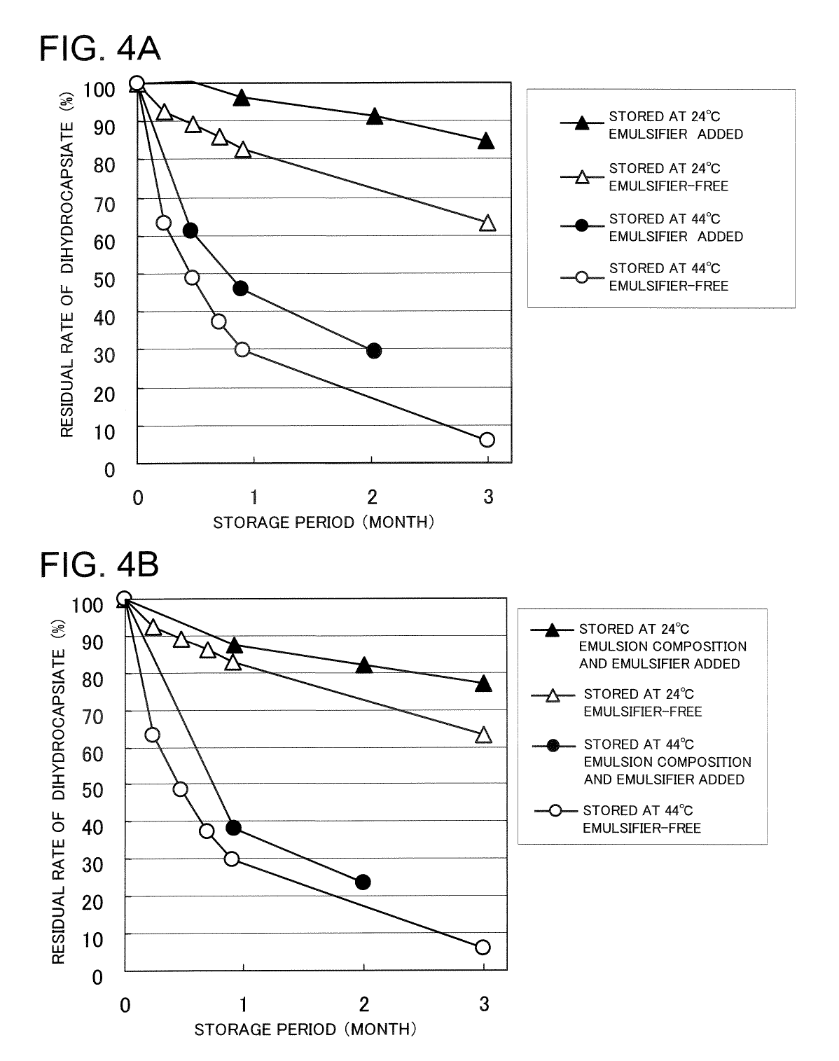

In periodical sampling, the content of capsinoid was determined. The content of capsinoid was analyzed by high performance liquid chromatography (HPLC) after dilution with a mixture of ethyl acetate and methanol (6:4). FIG. 4 shows the results. FIG. 4A indicates, similarly in Example 1, that dilution of the emulsion composition with a buffer to which an emulsifier was previously added improves the storage stability of dihydrocapsiate. Further, FIG. 4B indicates that dilution of the emulsion composition, to which an emulsifier was previously added, with a buffer containing no emulsifier, improves the storage stability of dihydrocapsiate, similarly in case of A.

Numerous modifications and variations on the present invention are possible in light of the above teachings. It is, therefore, to be understood that within the scope of the accompanying claims, the invention may be practiced otherwise than as specifically described herein.

1. A process of producing a capsinoid-containing food or drink, comprising
blending an oil phase comprising a capsinoid compound with an aqueous phase and an emulsifier to prepare an emulsion composition; and
mixing the emulsion composition with an aqueous component,
wherein an additional emulsifier and/or a high-molecular component is added to the emulsion composition, the aqueous component or a mixture thereof.

2. The process of claim 1, wherein the additional emulsifier and/or the high-molecular component is added during said mixing the emulsion composition with the aqueous component.

3. The process of claim 1, wherein the additional emulsifier and/or the high-molecular component is added to either or both of the emulsion composition and the aqueous component, prior to said mixing the emulsion composition with the aqueous component.

4. The process of claim 1, wherein said oil phase further comprises an oil thickener.

5. The process of claim 4, wherein said oil thickener is added at an amount ranging from 0.1 to 10% by mass based on the total mass of the oil phase.

6. The process of claim 4, wherein the viscosity of the capsinoid-containing oil phase is adjusted to a viscosity ranging from 50 to 350 mPa·s by addition of the oil thickener.

7. The process of claim 1, wherein said emulsifier is at least one emulsifier selected from the group consisting of polyglycerol fatty acid ester, sorbitan fatty acid ester, sucrose fatty acid ester, plyoxyethylene sorbitan fatty acid ester, and organic acid glycerate fatty acid ester.

8. The process of claim 1, wherein said emulsifier is in an amount ranging from 2 to 30% by mass based on the total of the oil phase, aqueous phase and emulsifier.

9. The process of claim 1, wherein said emulsifier is in an amount ranging from 3 to 25% by mass based on the total of the oil phase, aqueous phase and emulsifier.

10. The process of claim 1, wherein said emulsifier is a polyglycerin fatty acid ester and is present in an amount ranging from about 6 to 10% by mass based on the total of the oil phase, aqueous phase and emulsifier.

11. The process of claim 1, wherein said high-molecular weight component is at least high-molecular weight component selected from the group consisting of carrageenan, high methoxyl (HM) pectin, and sodium carboxymethylcellulose.

12. The process of claim 1, wherein the pH of the aqueous phase is adjusted to an acidic pH.

13. The process of claim 12, wherein the pH is adjusted to pH 2-6.

14. The process of claim 1, wherein said food or drink has a water content of at least 10% by mass.

15. The process of claim 1, wherein said food or drink is selected from the group consisting of an aqueous drink, a dairy product and an ice-cold confectionery.

16. A capsinoid-containing food or drink produced by the process of claim 1.

17. An emulsion composition with an improved stability of a capsinoid compound contained therein, comprising an emulsion composition prepared by blending an oil phase containing a capsinoid compound, an aqueous phase and an emulsifier, and supplemented with an additional emulsifier and/or a high-molecular component.
